(19) United States
(12) Patent Application Publication
(10) Pub. No.: US 2005/0018828 A1
(43) Pub. Date: Jan. 27, 2005

(54) System and method for indicating a speaker during a conference

(75) Inventors: Florian Patrick Nierhaus, Sunnyvale, CA (US); Wolgang Scheinhart, Antioch, CA (US); Tiruthani Saravanakumar, Cupertino, CA (US)

Correspondence Address: Attn: Elsa Keller, Legal Administrator;Siemens Corporation, Intellectual Property Department, 170 Wood Avenue South, Iselin, NJ, 08830, US

(73) Assignee: Siemens Information and Communication Networks, Inc.

(21) Appl. No.: 10/627,554

(22) Filed: Jul. 25, 2003

(51) Int. Cl. H04M 3/42; G06F 15/16

(52) U.S. Cl. 379/202.01; 709/204

(57) ABSTRACT

Embodiments provide a system, method, apparatus, means, and computer program code for identifying a speaker participating in a conference. During the conference or collaboration event, users may participate in the conference via user or client devices (e.g., computers) that are connected to or in communication with a server or collaboration system. A person participating in and/or moderating a conference may want to know which of the other participants is speaking at any give time, both for those participants that have a unique channel to the conference (e.g., a single participant participating in the conference via a single telephone or other connection) as well as participants that are aggregated behind a single channel to the conference (e.g., three participants in a conference room with a single telephone line or other connection to the conference).

### FIELD OF THE INVENTION

The present invention relates to telecommunications systems and, in particular, to an improved system and method for indicating a speaker during a conference.

### BACKGROUND

The development of various voice over IP protocols such as the H.323 Recommendation and the Session Initiation Protocol (SIP) has led to increased interest in multimedia conferencing. In such conferencing, typically, a more or less central server or other device manages the conference and maintains the various communications paths to computers or other client devices being used by parties to participate in the conference. Parties to the conference may be able to communicate via voice and/or video through the server and their client devices.

Instant messaging can provide an added dimension to multimedia conferences. In addition to allowing text chatting, instant messaging systems such as the Microsoft Windows Messenger™ system can allow for transfer of files, document sharing and collaboration, collaborative whiteboarding, and even voice and video. A complete multimedia conference can involve multiple voice and video streams, the transfer of many files, and marking-up of documents and whiteboarding.

During a conference, a participant in the conference may use a computer or other client type device (e.g., personal digital assistant, telephone, workstation) to participate in the conference. In addition, different or multiple participants may be speaking at points during the conference, sometimes at the same time. A conference participant may want to know who is speaking at any given point in time, especially in cases where not all of the conference participants are known to each other, or in cases where it may be difficult to understand what a participant is saying.

As such, there is a need for a system and method for identifying and displaying which participants during a conference are currently speaking.

### SUMMARY

Embodiments provide a system, method, apparatus, means, and computer program code for identifying and displaying which participants in a conference are currently speaking.

Additional objects, advantages, and novel features of the invention shall be set forth in part in the description that follows, and in part will become apparent to those skilled in the art upon examination of the following or may be learned by the practice of the invention.

In some embodiments, a method for identifying which participant in a conference call is currently speaking may include determining a list of participants in a conference; determining a sample from the conference; determining a participant from the list that is speaking during the sample; providing data indicative of the sample; and providing data indicative of the participant. In addition, the method may include accessing, receiving, or retrieving a list of participants for the conference and/or determining an active channel at the point in time. The method also may include providing participant identifying information as part of the same data stream as the sample data. Other embodiments may include means, systems, computer code, etc. for implementing some or all of the elements of the methods described herein.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate some embodiments, and together with the descriptions serve to explain the principles of the invention.

FIG. 1 is a diagram of a conference system according to some embodiments;

FIG. 2 is a diagram illustrating a conference collaboration system according to some embodiments;

FIG. 3 is another diagram illustrating a conference collaboration system according to some embodiments;

FIG. 4 is a diagram illustrating a graphical user interface according to some embodiments;

FIG. 5 is a diagram illustrating another graphical user interface according to some embodiments;

FIG. 6 is a diagram illustrating another graphical user interface according to some embodiments;

FIG. 7 is a flowchart of a method in accordance with some embodiments;

FIG. 8 is another flowchart of a method in accordance with some embodiments; and

FIG. 9 is a block diagram of possible components that may be used in some embodiments of the server of FIG. 1 and FIG. 3.

### DETAILED DESCRIPTION

Applicants have recognized that there is a market opportunity for systems, means, computer code, and methods that allow a participant speaking during a conference to be identified and indicated. During a conference, different participants may be in communication with a server or conference system via client devices (e.g., computers, telephones). The server or conference system may facilitate communication between the participants, sharing or accessing of documents, etc. A person participating in and/or moderating a conference may want to know which of the other participants is speaking at any given time or during a sample time period, both for those participants that have a unique channel to the conference (e.g., a single participant using a single telephone or other connection to participate in the conference) as well as participants that are aggregated behind a single channel to the conference (e.g., three participants in a conference room using a single telephone line or other connection to participate in the conference). In some embodiments, the server or conference system may identify or otherwise determine a participant that is speaking during wherein the participant is one of multiple participants that are aggregated on a channel.

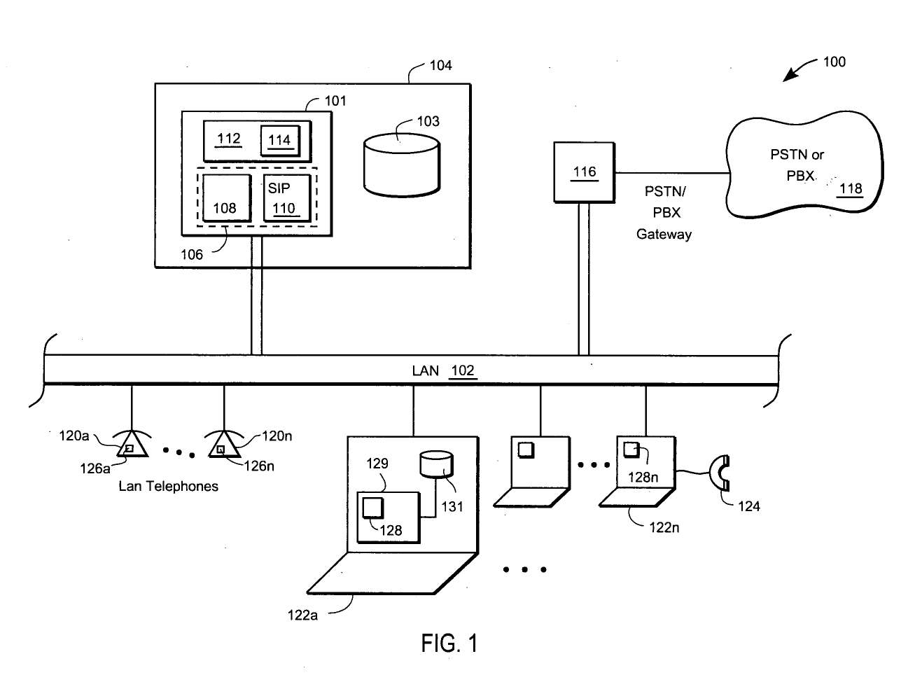

Referring now to FIG. 1, a diagram of an exemplary telecommunications or conference system 100 in some embodiments is shown. As shown, the system 100 may include a local area network (LAN) 102. The LAN 102 may be implemented using a TCP/IP network and may implement voice or multimedia over IP using, for example, the Session Initiation Protocol (SIP). Operably coupled to the local area network 102 is a server 104. The server 104 may include one or more controllers 101, which may be embodied as one or more microprocessors, and memory 103 for storing application programs and data. The controller 101 may implement an instant messaging system 106. The instant messaging system 106 may be embodied as a SIP proxy/register and SIMPLE clients or other instant messaging system (Microsoft Windows Messenger™ software) 110. In some embodiments, if possible and practicable, the instant messaging system 106 may implement or be part of the Microsoft.Net™ environment and/or the Real Time Communications server or protocol (RTC) 108.

In addition, in some embodiments, a collaboration system 114 may be provided, which may be part of an interactive suite of applications 112, run by controller 101, as will be described in greater detail below. In addition, an action prompt module 115 may be provided, which detects occurrences of action cues and causes action prompt windows to be launched at the client devices 122. The collaboration system 114 may allow users of the system to become participants in a conference or collaboration session.

Also coupled to the LAN 102 is a gateway 116 which may be implemented as a gateway to a private branch exchange (PBX), the public switched telephone network (PSTN) 118, or any of a variety of other networks, such as a wireless or cellular network. In addition, one or more LAN telephones 120a-120n and one or more computers 122a-122n may be operably coupled to the LAN 102. In some embodiments, one or more other types of networks may be used for communication between the server 104, computers 122a-122n, telephones 120a-120n, the gateway 116, etc. For example, in some embodiments, a communications network might be or include the Internet, the World Wide Web, or some other public or private computer, cable, telephone, client/server, peer-to-peer, or communications network or intranet. In some embodiments, a communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. Also, in some embodiments, one or more client devices (e.g., the computers 122a-122n) may be connected directly to the server 104.

The computers 122a-122n may be personal computers implementing the Windows XP™ operating system and thus, Windows Messenger™ instant messenger system, or SIP clients running on the Linux™ or other operating system running voice over IP clients or other clients capable of participating in voice or multimedia conferences. In addition, the computers 122a-122n may include telephony and other multimedia messaging capability using, for example, peripheral cameras, Web cams, microphones and speakers (not shown) or peripheral telephony handsets 124, such as the Optipoint™ handset, available from Siemens Corporation. In other embodiments, one or more of the computers may be implemented as wireless telephones, digital telephones, or personal digital assistants (PDAs). Thus, the figures are exemplary only. As shown with reference to computer 122a, the computers may include one or more controllers 129, such as Pentium™ type microprocessors, and storage 131 for applications and other programs.

Finally, the computers 122a-122n may implement interaction services 128a-128n in some embodiments. The interaction services 128a-128n may allow for interworking of phone, buddy list, instant messaging, presence, collaboration, calendar and other applications. In addition, the interaction services 128 may allow access to the collaboration system or module 114 and the action prompt module 115 of the server 104.

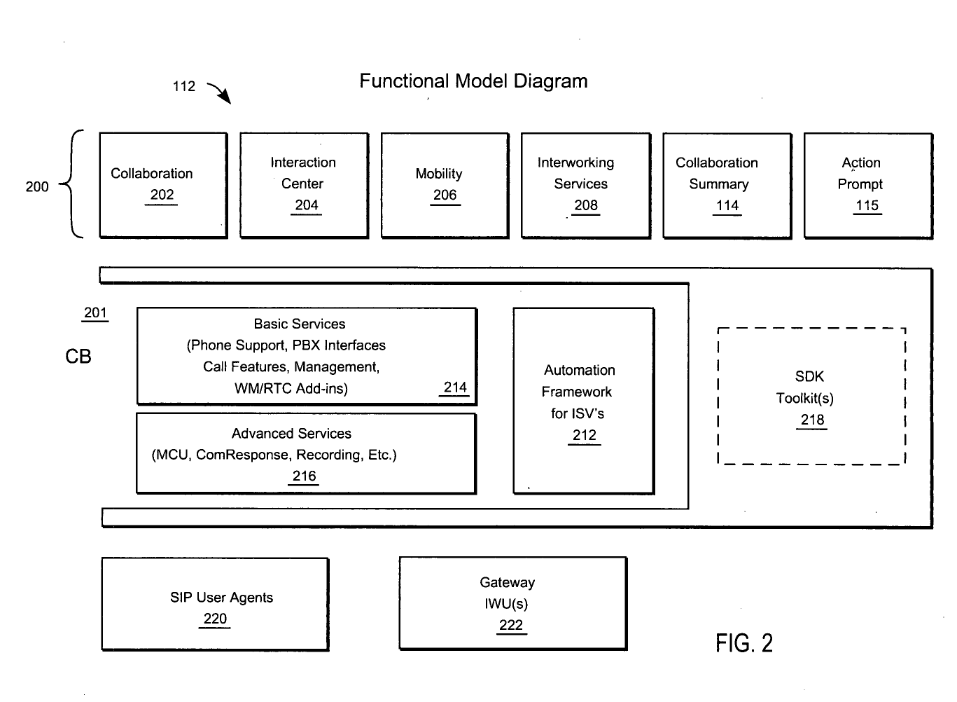

Turning now to FIG. 2, a functional model diagram illustrating the collaboration system 114 is shown. More particularly, FIG. 2 is a logical diagram illustrating a particular embodiment of a collaboration server 104. The server 104 includes a plurality of application modules 200 and a communication broker (CB) module 201. One or more of the application modules and communication broker module 201 may include an inference engine, i.e., a rules or heuristics based artificial intelligence engine for implementing functions in some embodiments. In addition, the server 104 provides interfaces, such as APIs (application programming interfaces) to SIP phones or other SIP User Agents 220 and gateways/interworking units 222.

According to the embodiment illustrated, the broker module 201 includes a basic services module 214, an advanced services module 216, an automation module 212, and a toolkit module 218. The automation module 212 implements an automation framework for ISVs (independent software vendors) 212 that allow products, software, etc. provided by such ISVs to be used with or created the server 104.

The basic services module 214 functions to implement, for example, phone support, PBX interfaces, call features and management, as well as Windows Messaging™ software and RTC add-ins, when necessary. The phone support features allow maintenance of and access to buddy lists and provide presence status.

The advanced services module 216 implements function such as presence, multipoint control unit or multi-channel conferencing unit (MCU), recording, and the like. MCU functions are used for voice conferencing and support ad hoc and dynamic conference creation from a buddy list following the SIP conferencing model for ad hoc conferences. In certain embodiments, support for G.711, G.723.1, or other codecs is provided. Further, in some embodiments, the MCU can distribute media processing over multiple servers using the MEGACO/H.248 protocol. In some embodiments, an MCU may provide the ability for participants to set up ad hoc voice, data, or multimedia conferencing sessions. During such conferencing sessions, different client devices (e.g., the computers 122a-122n) may establish channels to the MCU and the server 104, the channels carrying voice, audio, video and/or other data from and to participants via their associated client devices. In some cases, more than one participant may be participating in the conference via the same client device. For example, multiple participants may be using a telephone (e.g., the telephone 126a) located in a conference room to participate in the conference. Thus, the multiple participants are aggregated behind a single channel to participate in the conference. Also, in some cases, a participant may be using one client device (e.g., a computer) or multiple devices (e.g., a computer and a telephone) to participate in the conference. The Real-Time Transport Protocol (RTP) and the Real Time Control Protocol (RTCP) may be used to facilitate or manage communications or data exchanges between the client devices for the participants in the conference.

As will be discussed in more detail below, in some embodiments an MCU may include a conference mixer application or logical function that provides the audio, video, voice, etc. data to the different participants. The MCU may handle or manage establishing the calls in and out to the different participants and establish different channels with the client devices used by the participants. The server 104 may include, have access to, or be in communication with additional applications or functions that establish a list of participants in the conference as well as identify the participants speaking at a given moment during the conference.

Presence features provide device context for both SIP registered devices and user-defined non-SIP devices. Various user contexts, such as In Meeting, On Vacation, In the Office, etc., can be provided for. In addition, voice, e-mail, and instant messaging availability may be provided across the user's devices. The presence feature enables real time call control using presence information, e.g., to choose a destination based on the presence of a user's device(s). In addition, various components have a central repository for presence information and for changing and querying presence information. In addition, the presence module provides a user interface for presenting the user with presence information.

In addition, the broker module 201 may include the ComResponse™ platform, available from Siemens Information and Communication Networks, Inc. The ComResponse™ platform features include speech recognition, speech-to-text, and text-to-speech, and allows for creation of scripts for applications. The speech recognition and speech-to-text features may be used by the collaboration summarization unit 114 and the action prompt module 115.

In addition, real time call control is provided by a SIP API 220 associated with the basic services module 214. That is, calls can be intercepted in progress and real time actions performed on them, including directing those calls to alternate destinations based on rules and or other stimuli. The SIP API 220 also provides call progress monitoring capabilities and for reporting status of such calls to interested applications. The SIP API 220 also provides for call control from the user interface.

The toolkit module 218 may provide tools, APIs, scripting language, interfaces, software modules, libraries, software drivers, objects, etc. that may be used by software developers or programmers to build or integrate additional or complementary applications.

According to the embodiment illustrated, the application modules include a collaboration module 202, an interaction center module 204, a mobility module 206, an interworking services module 208, a collaboration summarization module 114, and an action prompt module 115.

The collaboration module 202 allows for creation, modification or deletion of a collaboration or conference session for a group of participants or other users. The collaboration module 202 may further allow for invoking a voice conference from any client device. In addition, the collaboration module 202 can launch a multi-media conferencing package, such as the WebEX™ package. It is noted that the multi-media conferencing can be handled by other products, applications, devices, etc.

The interaction center 204 provides a telephony interface for both subscribers and guests. Subscriber access functions include calendar access and voicemail and e-mail access. The calendar access allows the subscriber to accept, decline, or modify appointments, as well as block out particular times. The voicemail and e-mail access allows the subscriber to access and sort messages.

Similarly, the guest access feature allows the guest access to voicemail for leaving messages and calendar functions for scheduling, canceling, and modifying appointments with subscribers. Further, the guest access feature allows a guest user to access specific data meant for them, e.g., receiving e-mail and fax back, etc.

The mobility module 206 provides for message forwarding and “one number” access across media, and message “morphing” across media for the subscriber. Further, various applications can send notification messages to a variety of destinations, such as e-mails, instant messages, pagers, and the like. In addition, a user can set rules that the mobility module 206 uses to define media handling, such as e-mail, voice and instant messaging handling. Such rules specify data and associated actions. For example, a rule could be defined to say “If I'm traveling, and I get a voicemail or e-mail marked Urgent, then page me.”

Further, the collaboration summarization module 114 is used to identify or highlight portions of a multimedia conference and configure the portions sequentially for later playback. The portions may be stored or identified based on recording cues either preset or settable by one or more of the participants in the conference, such as a moderator. The recording cues may be based on vocalized keywords identified by the voice recognition unit of the ComResponse™ module, or may be invoked by special controls or video or whiteboarding or other identifiers.

The action prompt module 115 similarly allows a user to set action cues, which cause the launch of an action prompt window at the user's associated client device 122. In response, the client devices 122 can then perform various functions in accordance with the action cues.

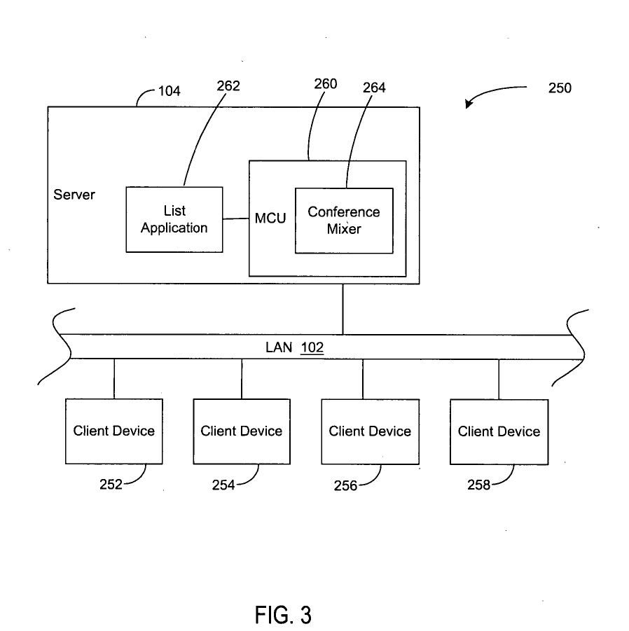

Now referring to FIG. 3, a system 250 is illustrated that provides a simplified version of, an alternative to, or a different view of the system 100 for purposes of further discussion. In some embodiments, some or all of the components illustrated in FIG. 2 may be included in the server 104 used with the system 250, but they are not required. The system 250 includes the server 104 connected via LAN 102 to a number of client devices 252, 254, 256, 258. Client devices may include computers (e.g., the computers 122a-122n), telephones (e.g., the telephones 126a-126n), PDAs, cellular telephones, workstations, or other devices. The client devices 252, 254, 256, 258 each may include the interaction services unit 128 previously discussed above. The server 104 may include MCU 260, which is in communication with list application or function 262. In some embodiments, the list application 262 may be part of, include in, or integrated with the MCU 260. The MCU 260 may communicate directly or indirectly with one or more of the client devices 252, 254, 256, 258 via one or more channels. In some embodiments, other devices may be placed in the communication paths between the MCU 260 and one or more of the client devices 252, 254, 256, 258 (e.g., a media processor may be connected to both the MCU 260 and the client devices to perform mixing and other media processing functions).

When a conference is established or operating, the MCU 260 may handle or manage establishing communication channels to the different client devices associated with participants in the conference. In some embodiments, the MCU 260 may use RTP channels to communicate with various client devices. In addition, or as an alternative, the MCU 260 may use side or other channels (e.g., HTTP channels) to communicate with the different client devices. For example, the MCU 260 may provide audio and video data to a client device using RTP, but may provide information via a side or different channel for display by an interface or window on the client device.

The MCU 260 also may include the conference mixer 264. The conference mixer 264 may take samples of the incoming voice and other signals on the different channels and send them out to the participants' client devices so that all of the participants are receiving the same information and data. Thus, the conference may be broken down into a series of sample periods, each of which may have some of the same active channels. Different sample periods during a conference may include different active channels.

The mixer 264 may use one or more mixing algorithms to create the mixed sample(s) from the incoming samples. The mixer 264 may then provide the mixed sample(s) to the client devices.

In some embodiments, a sample may be, include or use voice or signal data from only some of the channels being used in a conference. For example, a sample may include voice or other signals only from the two channels having the loudest speakers or which are considered the most relevant of the channels during the particular sample time.

Each sample provided by the mixer 264 may last for or represent a fixed or varied period of time during a conference. Different incoming samples may represent different periods of time during the conference. In addition, different samples may represent voice or other signals from different channels used by participants in the conference. In some embodiments, the mixer 264 also may provide the incoming samples or a mixed sample created from one or more of the incoming samples to the list application 262 or other part of the MCU 260 so that one or both can determine who is speaking during the specific sample period or in the selected sample(s).

In some embodiments, the mixer 264, using or in combination with its knowledge of a mixing algorithm used to create a mixed sample, may determine which participant is speaking during a mixed sample. Alternatively, in some embodiments, the MCU 260 or list application 262 may be aware of the mixing algorithm and determine which participant is speaking during the mixed sample. The list application 262 or the MCU 260 may then provide information back to the mixer 264 regarding who is speaking during the mixed sample.

When a conference is established or operating, the list application 262 may determine the participants in the conference and may be used to identify particular speakers during the conference based on its list of participants. In some embodiments, the list application 262 may be operating on a different device from the MCU 260. For example, the list application 262 may be part of another conferencing or signaling application that is operating on another device and communicates with the MCU 260 via a first channel and with client devices directly or indirectly via a second channel. In some embodiments, the list application 262 may provide information regarding the names of participants to the MCU 260.

The list application 262 may determine the list of participants from numerous sources or using numerous methods. For example, in some embodiments, the list application 262 may access a list of invitees to the conference which may be manually entered or selected by a person organizing or facilitating the conference. As another example, the list application 262 may receive information from the MCU 260 regarding the client devices participating in the conference and/or the people associated with the client devices. As another example, the MCU 260 may provide an audio stream or audio data to the list application 262. The list application then may use voice or name recognition techniques to extract names or excerpts from the audio stream or data. Audio excerpts may be matched against a previously created list of names, specific key words, phrases, or idioms (e.g., “My name is Paul”,“Hi, this is Sam”), buddy list entries, contact lists, etc. to help recognize names. As another example, if a conference is associated with a particular organization or group, information about members of the organization or group may be used to build or as input to the participant list. In a further example, the list application 262 may use protocol information from the audio or other sessions in a conference to build the participant list. As a more specific example, the list application 262 may obtain data from the CNAME, NAME, and/or EMAIL fields used in RTP/RTCP compliant audio sessions.

In some embodiments, the MCU 260 or the list application 262 may be able to detect and differentiate between multiple participants aggregated behind or associated with a single channel. Thus, the MCU 260 or the list application 262 may be able to determine how many participants are sharing a channel in the conference and/or detect which of the participants are speaking at given points in time. The MCU 260 or the list application 262 may use speaker recognition or other speech related technologies, algorithms, etc. to provide such functions.

In some embodiments, the MCU 260 and/or the list application 262 may be able to detect which of the channels being used by the client devices participating in the conference are the most significant or indicate the level of activity of the different channels (which may be relative or absolute). The MCU 260 or the list application 262 may use voice activity detection, signal energy computation, or other technology, method or algorithm to provide such functions.

The MCU 260 and/or the list application 262 may correlate source information from the different channels to the list of participants previously created. For example, if there is only one speaker (e.g., a single source) on a channel to a client device, the list application 262 may associate the owner of the client device with the speaker. If there are multiple sources (e.g., multiple speakers) on a channel, each speaker may be correlated to or associated with a name from the participation list or a name that was recognized via voice or speech recognition. If the multiple sources cannot be distinguished, a single participant may be associated with or assigned to the channel or to the source (e.g., the device providing the signal on the channel). The mixer 264 may provide the source and channel information to one or more of the client devices being used in the conference as a way of identifying a participant associated with the source and/or channel.

In some embodiments, based on information provided by the list application 262 or other part of the MCU 260, the conference mixer 264 may identify zero, one or multiple participants for each channel which are active or which have been active over a certain amount of time (e.g., active within the last half second). In addition, the conference mixer 264 may determine the significance of each of the channels. The conference mixer 264 can send out samples containing the audio or voice data for a period of time (e.g., fifty milliseconds) to the client devices 252, 254, 256, 258. The sample may include voice data from all of the active channels, only the most significant channels, or a fixed number of channels. In addition, the mixer 264 may send information to the client devices regarding which channels and/or which speakers are active in the sample. In some embodiments, the mixer 264 may be able to provide data regarding samples, speakers, etc. in real time or near to real time.

In some embodiments, the mixer 264, as part of the MCU 260, may send the mixed sample via one channel (e.g., an RTP based channel) and the speaker/channel information via a separate channel (e.g., an HTML communication via a Web server), particularly when the participant is using one client device (e.g., the telephone126a) to participate in the conference, provide audio to the conference, receive samples from the mixer 264, etc. and a different client device (e.g., the computer 122a) to receive information and interface data from the mixer 264 regarding the conference. When a client device receives the mixed sample from the mixer 264, the client device can play the mixed sample for the participant associated with the client device. When a client device receives the speaker/channel information, the client device may display some or all of the speaker/channel information to the participant associated with the client device.

In some embodiments, based on operation of or information from the list application 262 or the MCU 260, the conference mixer 264 may determine the significance of each source (e.g., speaker) within a channel absolute or relative to the other sources in the same channel and/or in different channels or may indicate the most significant source to client devices.

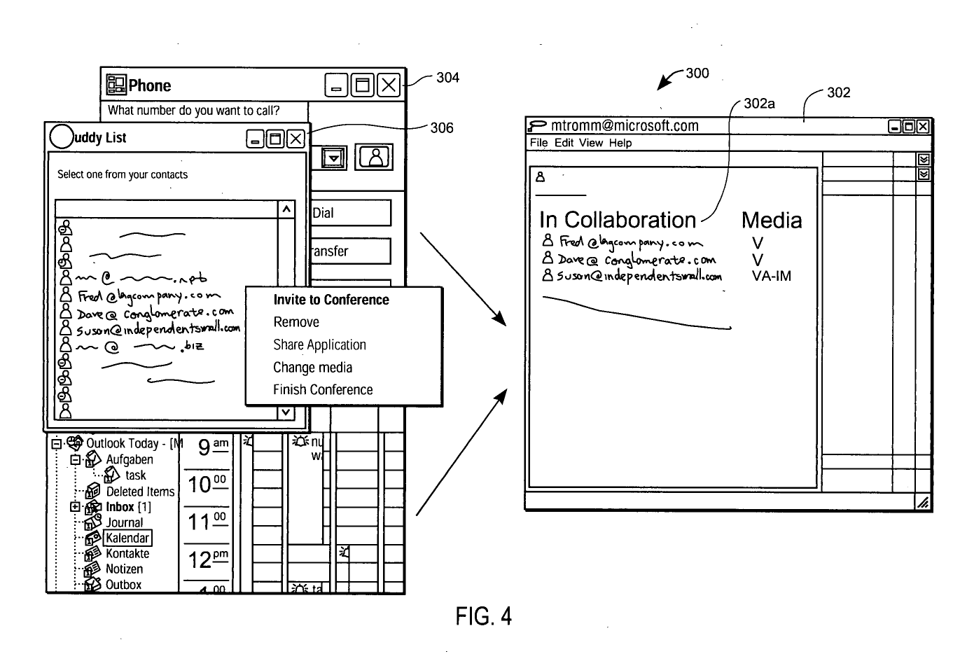

Turning now to FIG. 4, a diagram of a graphical user interface 300 according to some embodiments is shown. In particular, shown are a variety of windows for invoking various functions. Such a graphical user interface 300 may be implemented on one or more of the client devices 252, 254, 256, 258. Thus, the graphical user interface 300 may interact with the interactive services unit 128 to control collaboration sessions or with the MCU 260.

Shown are a collaboration interface 302, a phone interface 304, and a buddy list 306. It is noted that other functional interfaces may be provided. According to some embodiments, certain of the interfaces may be based on, be similar to, or interwork with, those provided by Microsoft Windows Messenger™ or Outlook™ software.

In some embodiments, the buddy list 306 may be used to set up instant messaging calls and/or multimedia conferences. The phone interface 304 is used to make calls, e.g., by typing in a phone number, and also allows invocation of supplementary service functions such as transfer, forward, etc. The collaboration interface 302 allows for viewing the parties to a conference or collaboration 302a and the type of media involved. It is noted that, while illustrated in the context of personal computers 122, similar interfaces may be provided the telephones or cellular telephones or PDAs. During a conference or collaboration, participants in the conference or collaboration may access or view shared documents or presentations, communicate with each other via audio, voice, data and/or video channels, etc.

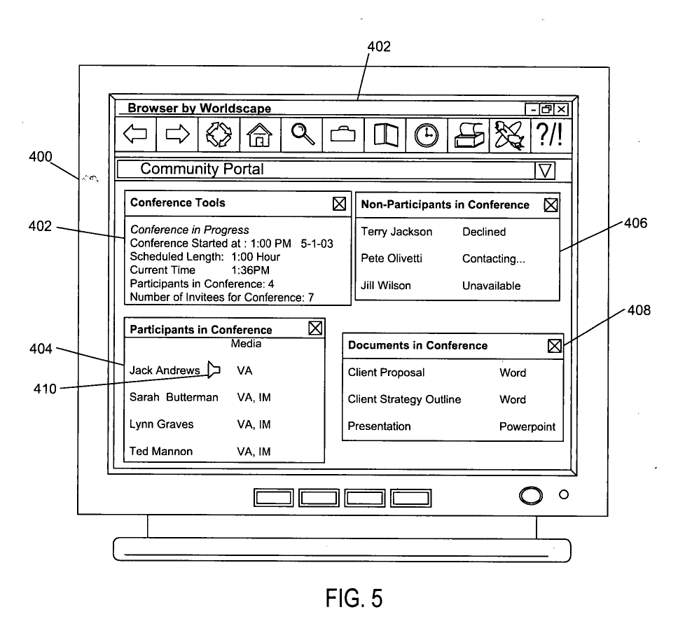

Now referring to FIG. 5, a monitor 400 is illustrated that may be used as part of a client device (e.g., the client device 302) by a user participating, initiating, or scheduling a conference. The monitor 400 may include a screen 402 on which representative windows or interfaces 402, 404, 406, 408 may be displayed. In some embodiments, the monitor 400 may be part of the server 104 or part of a client device (e.g., 122a-122n, 252-258). While the windows or interfaces 302, 304, 306 illustrated in FIG. 4 provided individual users or client devices (e.g., the computer 122a) the ability to participate in conferences, send instant messages or other communications, etc., the windows or interfaces 402, 404, 406, 408 may allow a person using or located at the server 104 and/or one or more of the client computers 122a-122n the ability to establish or change settings for a conference, monitor the status of the conference, and/or perform other functions. In some embodiments, some or all of the windows, 402, 404, 406, 408 may not be used or displayed and/or some or all of the windows 402, 404, 406, 408 might be displayed in conjunction with one or more of the windows 302, 304, 306.

In some embodiments, one or more of the windows 402, 404, 406, 408 may displayed as part of a “community portal” that may include one or more Web pages, Web sites, or other electronic resources that are accessible by users participating in a conference, a person or device monitoring, controlling or initiating the conference, etc. Thus, the “community portal” may include information, documents, files, etc. that are accessible to multiple parties. In some embodiments, some or all of the contents of the community portal may be established or otherwise provided by one or more people participating in a conference, a person scheduling or coordinating the conference on behalf of one or more other users, etc.

As indicated in FIG. 5, the window 402 may include information regarding a conference in progress, the scheduled date of the conference (i.e., 1:00 PM on May 1, 2003), the number of participants in the conference, the number of invitees to the conference, etc.

The window 404 includes information regarding the four current participants in the conference, the communication channels or media established with the four participants, etc. For example, the participant named “Jack Andrews” is participating in the conference via video and audio (e.g., a Web cam attached to the participant's computer). The participants named “Sarah Butterman,” “Lynn Graves,” and “Ted Mannon” are participating in the conference via video and audio channels and have IM capabilities activated as well. The participants named “Sarah Butterman,” “Lynn Graves,” and “Ted Mannon” may use the IM capabilities to communicate with each other or other parties during the conference.

In some embodiments, the window 404 may display an icon 410 next to a participants name to indicate that the speaker is currently speaking during the conference. For example, the placement of the icon 410 next to the name “Jack Andrews” indicates that he is currently speaking. When multiple participants are speaking, icons may be placed next to the all of the participants currently identified as speaking during the conference. Thus, icons may appear next to different names in the window 404 and then disappear as different speakers are talking during a conference. In some embodiments the icon 410 may flash, change colors, change size, change brightness, etc. as further indication that a participant is speaking or is otherwise active in the conference.

As an alternative or an addition to placing an icon next to a participant's name when the participant is speaking during a conference, in some embodiments the participant's name may flash, change colors, change font type or font size, be underlined, be bolded, etc.

The window 406 includes information regarding three people invited to the conference, but who are not yet participating in the conference. As illustrated in the window 406, the invitee named “Terry Jackson” has declined to participate, the invitee named “Jill Wilson” is unavailable, and the server 104 or the collaboration system 114 currently is trying to establish a connection or communication channel with the invitee named “Pete Olivetti.”

The window 408 includes information regarding documents that may be used by or shared between participants in the conference while the conference is on-going. In some embodiments, access to and/or use of the documents also may be possible prior to and/or after the conference.

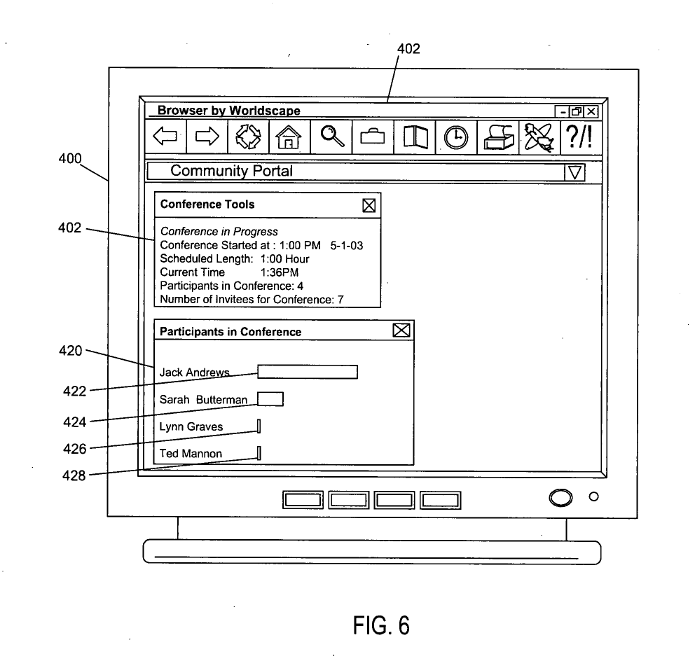

Now referring to FIG. 6, another window 420 is illustrated that may indicate when one or more participants in a conference is speaking, the relative strength or activity of the participants in the conference, etc. The window 420 may display the names of the participants in the conference in a manner similar to the window 402. In addition, the window 420 may include graphs or bars 422, 424, 426, 428 next to the participants' names, each graph or bar indicating the relative participation level or loudness of the different speakers, their level of participation or activity in a conference or conference sample, etc. For example, the size of the bar 422 associated with the participant “Jack Andrews” relative to the size of the bar 424 associated with the participant “Sarah Butterman” may indicate that the participant “Jack Andrews” is speaking louder than the participant “Sarah Butterman”, is more active in the conference than the participant “Sarah Butterman”, etc. The size of the graphs or bars 422, 424, 426, 428 may change during the conference to indicate the changing nature of the participation of the four participants in the conference.

In some embodiments, any of the before mentioned examples discussed regarding FIG. 5 may be modified to give a relative strength or activity indication. For example, the blinking rate, size, color, or brightness of icons or a participant's name may indicate the strength of the activity.

Process Description

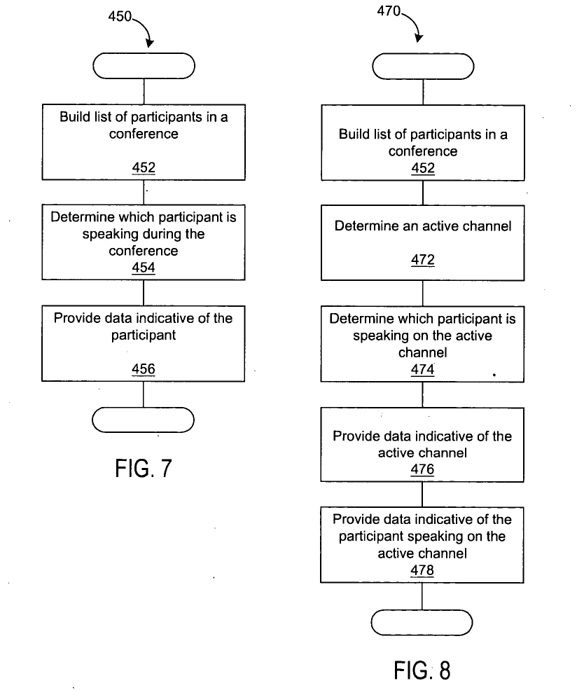

Reference is now made to FIG. 7, where a flow chart 450 is shown which represents the operation of a first embodiment of a method. The particular arrangement of elements in the flow chart 450 is not meant to imply a fixed order to the elements; embodiments can be practiced in any order that is practicable. In some embodiments, some or all of the elements of the method 450 may be performed or completed by the server 104, MCU 260, and list application 262, or another device or application, as will be discussed in more detail below.

Processing begins at 452 during which the list application 362 and/or server 114 builds a list of participants in a conference, as previously discussed above. In some embodiments, 452 may be or include accessing, receiving, or retrieving the list of participants.

During 454, the MCU 260 or the list application 362 identifies or otherwise determines which participant is speaking at a given time during the conference. In some cases, more than one participant may be speaking at a given time. In some embodiments, the mixer 264 may determine a sample of voice data and the MCU 310 or list application 362 may determine which participants are speaking in the sample and provide information back to the mixer 264 regarding who is speaking in a given sample or at a given time. The sample may include the given time or a designated time period.

During 456, the MCU 260 sends or otherwise provides data indicative of the speaker to a client device. In some embodiments, 456 may be performed by the mixer 264 within the MCU 260. Such speaker data may be provided to the same device as a mixed sample or to a different device. Similarly, the speaker data may be provided via the same channel as the mixed sample or via a different channel. In some embodiments, the MCU 260 may provide the speaker data as part of, included in, or integral with, the mixed sample.

Reference is now made to FIG. 8, where a flow chart 470 is shown which represents the operation of another embodiment of a method. The particular arrangement of elements in the flow chart 470 is not meant to imply a fixed order to the elements; embodiments can be practiced in any order that is practicable. In some embodiments, some or all of the elements of the method 470 may be performed or completed by the server 104, MCU 260 and list application 262, or another device or application, as will be discussed in more detail below.

The method 470 includes 452 previously discussed above. In addition, the method 470 includes 472 during which the MCU 260 identifies or otherwise determines one or more active channels for the conference at a given point in time or for a given time period (e.g., a given sample period). In some embodiments, the MCU 260 may identify the significance of one or more channels being used to participant in the conference, either on an absolute or relative basis. The MCU 260 may select one or more (e.g., the three loudest) active channels and select a sample from the selected active channels. Thus, in some embodiments, determining an active channel for a conference may include determining a significance of a plurality of channels being used during the conference and selecting at least one active channel from the plurality of active channels. The sample may be taken from the selected channels from the plurality of active channels based on the significance of the active channels. The mixer 264 may use samples from the active channels to create a mixed sample for the sample period

During 474, the MCU 260 may identify or otherwise determine which participant is speaking on the active channel for the given point in time. The given point in time may fall within a time period of a sample of the active channel(s) determined during 472. If a sample includes voice data from multiple channels, the MCU 260 may determine which participants on the multiple channels are active or speaking in or during the sample. In some embodiments, the list application 362 may assist or be used in 474. In some embodiments, determining a speaker may include determining an active channel in the sample and determining a speaker speaking on or otherwise associated with the active channel.

During 476, the MCU 260 sends or otherwise provides a sample of voice data for a given period of time (e.g., data indicative of the active channel(s) determined during 472). In some embodiments, the sample may include voice or other signals from the active channel(s) determined during 472 and/or other multiple active channels (e.g., the three loudest active channels). Thus, in some embodiments, the sample may be or include a mixed sample created by the mixer 264.

During 478 the MCU 260 sends or otherwise provides data indicative of one or more participants in the conference speaking during the sample time period, which may include one or more participants speaking on the active channel determined during 472. In some embodiments, the MCU 260 may send the sample data to the same client device as the speaker data or to a different device. Similarly, in some embodiments, the MCU 260 may send the sample data via the same channel as the speaker data or via a different channel. In some embodiments, the data indicative of a participant may include data indicative of a device associated with a participant and/or data indicative of a channel associated with the participant (e.g., the channel determined during 472).

In some embodiments, the data indicative of the sample may have a different sample size than the data indicative of said participant. That is, the data sample size for voice samples and for indications of participants do not have to be tightly synchronized. For example, the data sample size for participant indications may be larger than the size of a data voice sample. This can be true both in the scenario where the same channel is used (e.g., the participant indication data is attached to the voice sample) or separate channels are used. If data indicating one or more participants speaking during a sample time is attached to voice sample data, the data indicating the speaker also can be retransmitted or sent via other channels. Furthermore, the size or amount of data indicating participants may vary and does not need to be fixed. For example, the list application 262 may create indication data as events when it detects a relevant change in multiple voice samples or part of a voice sample.

In some embodiments, the method 470 may include causing a display of an indication of the participant determined during 474 on one or more user or client device being used by participants in the conference. Also, the MCU 260 may send or otherwise provide data indicative of some or the entire list determined during 452.

As another view of the method for identifying a speaker during a conference based on the discussion of the methods above, in some embodiments the MCU 260 may determine a list of participants in a conference; determine a sample from the conference; determine a participant from the list that is speaking during the sample; provide data indicative of the sample; and provide data indicative of the participant. Determining a speaker may include determining an active channel in the sample and determining a speaker speaking on or otherwise associated with the active channel.

Server

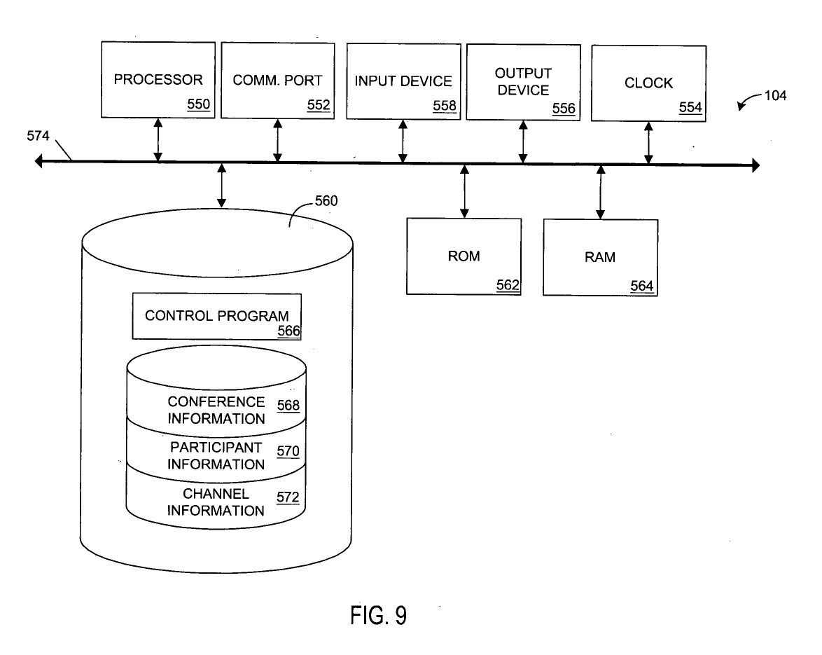

Now referring to FIG. 9, a representative block diagram of a server or controller 104 is illustrated. The server 104 can comprise a single device or computer, a networked set or group of devices or computers, a workstation, mainframe or hose computer, etc., and may include the components described above in regards to FIG. 1. In some embodiments, the server 104 may be adapted or operable to implement one or more of the methods disclosed herein. The server 104 also may include some or all of the components discussed above in relation to FIG. 1 and/or FIG. 2.

The server 104 may include a processor, microchip, central processing unit, or computer 550 that is in communication with or otherwise uses or includes one or more communication ports 552 for communicating with user devices and/or other devices. The processor 550 may be operable or adapted to conduct, implement, or perform one or more of the elements in the methods disclosed herein.

Communication ports may include such things as local area network adapters, wireless communication devices, Bluetooth technology, etc. The server 104 also may include an internal clock element 554 to maintain an accurate time and date for the server 104, create time stamps for communications received or sent by the server 104, etc.

If desired, the server 104 may include one or more output devices 556 such as a printer, infrared or other transmitter, antenna, audio speaker, display screen or monitor (e.g., the monitor 400), text to speech converter, etc., as well as one or more input devices 558 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 104 may include a memory or data storage device 560 (which may be or include the memory 103 previously discussed above) to store information, software, databases, documents, communications, device drivers, etc. The memory or data storage device 560 preferably comprises an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 104 also may include separate ROM 562 and RAM 564.

The processor 550 and the data storage device 560 in the server 104 each may be, for example: (i) located entirely within a single computer or other computing device; or (ii) connected to each other by a remote communication medium, such as a serial port cable, telephone line or radio frequency transceiver. In one embodiment, the server 104 may comprise one or more computers that are connected to a remote server computer for maintaining databases.

A conventional personal computer or workstation with sufficient memory and processing capability may be used as the server 104. In one embodiment, the server 104 operates as or includes a Web server for an Internet environment. The server 104 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 550. Equivalent processors are available from Motorola, Inc., AMD, or Sun Microsystems, Inc. The processor 550 also may comprise one or more microprocessors, computers, computer systems, etc.

Software may be resident and operating or operational on the server 104. The software may be stored on the data storage device 560 and may include a control program 566 for operating the server, databases, etc. The control program 566 may control the processor 550. The processor 550 preferably performs instructions of the control program 566, and thereby operates in accordance with the embodiments described herein, and particularly in accordance with the methods described in detail herein. The control program 566 may be stored in a compressed, uncompiled and/or encrypted format. The control program 566 furthermore includes program elements that may be necessary, such as an operating system, a database management system and device drivers for allowing the processor 550 to interface with peripheral devices, databases, etc. Appropriate program elements are known to those skilled in the art, and need not be described in detail herein.

The server 104 also may include or store information regarding users, user devices, conferences, alarm settings, documents, communications, etc. For example, information regarding one or more conferences may be stored in a conference information database 568 for use by the server 104 or another device or entity. Information regarding one or more users (e.g., invitees to a conference, participants to a conference) may be stored in a user information database 570 for use by the server 104 or another device or entity and information regarding one or more channels to client devices may be stored in an channel information database 572 for use by the server 104 or another device or entity. In some embodiments, some or all of one or more of the databases may be stored or mirrored remotely from the server 104.

In some embodiments, the instructions of the control program may be read into a main memory from another computer-readable medium, such as from the ROM 562 to the RAM 564. Execution of sequences of the instructions in the control program causes the processor 550 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 550, communication port 552, clock 554, output device 556, input device 558, data storage device 560, ROM 562, and RAM 564 may communicate or be connected directly or indirectly in a variety of ways. For example, the processor 550, communication port 552, clock 554, output device 556, input device 558, data storage device 560, ROM 562, and RAM 564 may be connected via a bus 574.

As described above, in some embodiments, a system for indicating a speaker during a conference may include a processor; a communication port coupled to the processor and adapted to communicate with at least one device; and a storage device coupled to the processor and storing instructions adapted to be executed by the processor to determine a list of participants in a conference; determine a sample from the conference; determine a participant from the list that is speaking during the sample; provide data indicative of the sample; and provide data indicative of the participant. In some other embodiments, a system for indicating a speaker during a conference, may include a network; at least one client device operably coupled to the network; and a server operably coupled to the network, the server adapted to determine a list of participants in a conference; determine a sample from the conference; determine a participant from the list that is speaking during the sample; provide data indicative of the sample; and provide data indicative of the participant.

While specific implementations and hardware configurations for the server 104 have been illustrated, it should be noted that other implementations and hardware configurations are possible and that no specific implementation or hardware configuration is needed. Thus, not all of the components illustrated in FIG. 9 may be needed for the server 104 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the elements for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the elements in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention. The invention described in the above detailed description is not intended to be limited to the specific form set forth herein, but is intended to cover such alternatives, modifications and equivalents as can reasonably be included within the spirit and scope of the appended claims.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1. A method for indicating a speaker during a conference, comprising:
determining a list of participants in a conference;
determining a sample from said conference;
determining a participant from said list that is speaking during said sample;
providing data indicative of said sample; and
providing data indicative of said participant.

2. The method of claim 1, wherein said determining a participant from said list that is speaking during said sample includes determining an active channel in said sample and determining a speaker associated with said active channel.

3. The method of claim 1, further comprising:
causing a display of an indication that said participant is speaking.

4. The method of claim 1, further comprising:
determining at least one active channel in said conference.

5. The method of claim 4, wherein said determining at least one active channel includes determining significance of a plurality of channels in said conference and selecting said at least one active channel from said plurality of channels.

6. The method of claim 4, wherein said determining a sample from said conference includes determining a sample from said at least one active channel.

7. The method of claim 1, wherein said providing data indicative of said sample includes providing a sample of voice data associated with said conference.

8. The method of claim 7, wherein said providing data indicative of said participant includes providing said data via a first channel and wherein said providing a sample of voice data associated with said conference includes providing said sample of voice data via a second channel.

9. The method of claim 7, wherein said providing data indicative of said participant includes providing said data to a first client device and wherein said providing a sample of voice data associated with said conference includes providing said sample of voice data to a second client device.

10. The method of claim 1, further comprising:
determining a significance of at least one active channel in said conference.

11. The method of claim 10, wherein said determining a participant from said list that is speaking during said sample includes identifying a participant speaking on said at least one active channel during said sample.

12. The method of claim 1, wherein said data indicative of said participant includes data indicative of a device associated with said participant.

13. The method of claim 1, wherein said data indicative of said participant includes data indicative of a channel associated with said participant.

14. The method of claim 1, wherein said sample includes data from multiple active channels associated with said conference.

15. The method of claim 1, wherein said determining a participant from said list that is speaking during said sample includes determining a participant from a plurality of participants that are aggregated on a channel.

16. The method of claim 1, wherein said data indicative of said sample has a different sample size than said data indicative of said participant.

17. A system for indicating a speaker during a conference, comprising:
a network;
at least one client device operably coupled to said network; and
a server operably coupled to said network, said server adapted to determine a list of participants in a conference; determine a sample from said conference; determine a participant from said list that is speaking during said sample; provide data indicative of said sample; and provide data indicative of said participant.

18. The system of claim 17, wherein said server is adapted to determine an active channel associated with said conference.

19. The system of claim 17, wherein said server is adapted to cause a display on said client device of an indication that said participant is speaking.

20. The system of claim 17, wherein said client device is adapted to display an indication of said participant.

21. The system of claim 17, wherein said client device is adapted to display a level of activity of said participant in said sample.

22. A system for indicating a speaker during a conference, comprising:
a processor;
a communication port coupled to said processor and adapted to communicate with at least one device; and
a storage device coupled to said processor and storing instructions adapted to be executed by said processor to:
determine a list of participants in a conference;
determine a sample from said conference;
determine a participant from said list that is speaking during said sample;
provide data indicative of said sample; and
provide data indicative of said participant.

23. An article of manufacture comprising:
a computer readable medium having stored thereon instructions which, when executed by a processor, cause said processor to:
determine a list of participants in a conference;
determine a sample from said conference;
determine a participant from said list that is speaking during said sample;
provide data indicative of said sample; and
provide data indicative of said participant.
